(19) United States
(12) Patent Application Publication
(10) Pub. No.: US 2026/0153190 A1
(43) Pub. Date: Jun. 4, 2026

(54) STORAGE CONTAINER

(71) Applicant: LINDE GMBH, Pullach (DE)

(72) Inventors: Stefan FELBINGER, Pullach (DE); Petya TONEVA, Pullach (DE); Nabeel HAKEMI, Pullach (DE); Johannes SCHAFRANEK, Pullach (DE); Heinz POSSELT, Pullach (DE); Harald ZENZ, Pullach (DE); Eva MÜLLER, Pullach (DE); Denis DURNEV, Pullach (DE); Clemens WOLFERSTETTER, Pullach (DE); Anton WELLENHOFER, Pullach (DE)

(21) Appl. No.: 19/123,646

(22) PCT Filed: Oct. 24, 2023
(86) PCT No.: PCT/EP2023/025445

§ 371 Date: Apr. 23, 2025

(30) Foreign Application Priority Data
Oct. 26, 2022 (EP) 22020519.9

(51) Int. Cl. A01N 1/145; H05B 3/34

(52) U.S. Cl. CPC F17C 3/08; F17C 2203/0391; F17C 2221/012; F17C 2223/0161; F17C 2227/0369

(57) ABSTRACT

A storage container for storing a cryogen (H2), having an inner container for holding the cryogen, an outer container enclosing the inner container, and a heating device for pressure build-up within the inner container by introducing heat into the cryogen (H2), wherein the heating device has a length compensator which is designed to compensate for a heat-induced change in length of the inner container.

The invention relates to a storage container for storing a cryogen.

According to internal company knowledge, storage containers for liquid hydrogen can have a heating device which makes it possible to build up a predetermined pressure within the storage container. Such storage containers are substantially cylindrical or barrel-shaped and comprise an inner container for holding the hydrogen as well as an outer container that encloses the inner container. A vacuum space with a vacuum is provided between the inner container and the outer container.

The heating device is guided from the surroundings of the storage container through this vacuum space into the inner container, for example for the replacement thereof. The heating device must be able to be removed or installed without breaking the vacuum. Furthermore, a heat-induced change in length of the inner container, for example when the cryogen is filled into the inner container, which can be firmly connected to the outer container, should not lead to any mechanical stresses in the outer container, the inner container and/or the heating device.

Against this background, it is an object of the present invention to provide an improved storage container.

Accordingly, a storage container for storing a cryogen is proposed. The storage container comprises an inner container for holding the cryogen, an outer container enclosing the inner container, and a heating device for pressure build-up within the inner container by introducing heat into the cryogen, wherein the heating device has a length compensator which is designed to compensate for a heat-induced change in length of the inner container.

By providing the length compensator, the heat-induced change in length of the inner container can be compensated in such a way that when filling the cryogen into the inner container, no stresses are introduced into the heating device, the inner container and/or the outer container due to heat-induced shrinkage of the inner container.

In particular, the length compensator is designed to compensate for the heat-induced change in length of the inner container along a longitudinal direction of the storage container. In addition, a change in length in a radial direction of the storage container can also be compensated. However, this is optional.

The cryogen is preferably hydrogen. The terms, “cryogen” and “hydrogen,” are therefore interchangeable as desired. In principle, however, the cryogen may also be any other cryogen. Examples of cryogenic fluids or liquids, or cryogens for short, are, in addition to the aforementioned hydrogen, liquid helium, liquid nitrogen, or liquid oxygen. A “cryogen” is thus to be understood in particular as a liquid. The cryogen can therefore also be referred to as a cryogenic fluid.

The cryogen can be vaporized and thus converted into a gaseous phase. After vaporization, the cryogen is a gas or can be referred to as gaseous or vaporized cryogen. The term “cryogen” can thus comprise both, namely the gas phase and the liquid phase. As mentioned before, the liquid phase can also be referred to as cryogenic fluid. The term “vaporized cryogen” here refers preferably only to the gas phase of the cryogen.

A gas zone, in particular in the inner container of the storage container, and an underlying liquid zone are formed in the storage container after or while filling the cryogen into the storage container. A phase boundary is provided between the gas zone and the liquid zone. The heating device is arranged in particular at least partially within the inner container, in particular in the liquid zone.

After being filled into the storage container, the cryogen therefore preferably has two phases with different aggregate states, i.e., liquid and gaseous. The liquid-state phase can transition into the gaseous phase, and vice versa. The liquid phase can be referred to as a liquid phase. The gaseous phase can be referred to as a gas phase. A purely liquid filling of the storage container is also possible.

The pressure prevailing in the storage container is preferably approximately 3.5 bara. The pressure prevailing in the storage container is in particular constant. The storage container is in particular suitable for supplying a consumer with the gaseous phase or the liquid phase of the cryogen at a suitable supply pressure and a suitable temperature. The consumer can be a fuel cell. In the present case, a “fuel cell” is in particular understood to mean a galvanic cell that converts the chemical reaction energy of a continuously supplied fuel—in the present case, hydrogen—and of an oxidant—in the present case, oxygen—into electrical energy.

The cryogen is supplied to the consumer itself in particular in gaseous form. This means that the cryogen is completely vaporized or heated before the consumer or upstream from the consumer if the gaseous phase is supplied directly from the storage container. For example, the cryogen is supplied to the consumer with a supply pressure of 1 to 2.5 bara and a temperature of +10° C. to +25° C. However, the supply pressure can also be up to 6 bara.

The storage container is preferably assigned an axis of symmetry or center axis with respect to which the storage container is built substantially rotationally symmetrical. In cross section, the storage container can therefore have a circular or annular cross section. In contrast, however, the storage container can also be oval or elliptical in cross section. In particular, the inner container and the outer container are each built rotationally symmetrical in relation to the center axis.

The inner container and the outer container each comprise a tubular base section which is rotationally symmetrical in relation to the center axis. The inner container and the outer container are each closed fluid-tightly at the front by means of cover sections. The inner container and the outer container are in particular fluid-tight. The inner container and the outer container can, for example, be made of a metallic material, in particular stainless steel. The inner container is arranged completely inside the outer container. This means in particular that the outer container completely encloses the inner container.

The heating device can be led from the surroundings of the storage container through the outer container and the inner container into the inner container, in particular into the liquid zone of the inner container. For this purpose, the heating device can, for example, be passed through the respective cover sections of the inner container and the outer container. In particular, the heating device is placed below the phase boundary in the liquid zone so that the heating device is always surrounded or flushed by the liquid phase of the cryogen.

The heating device is in particular designed to introduce heat directly into the liquid phase of the cryogen. To introduce the heat, the heating device preferably comprises a heating unit comprising a heating element which is carried by a support element. By introducing heat into the cryogen, it is at least partially vaporized, whereby a pressure build-up can be achieved within the storage container, in particular within the inner container.

The storage container preferably has a pressure sensor for measuring the internal pressure of the inner container. This allows the pressure in the inner container to be monitored.

Preferably, the storage container has a control device which is connected to the pressure sensor and to the heating device. This makes it possible to regulate the pressure within the inner container.

The heating device is preferably assigned an axis of symmetry or center axis with respect to which the heating device is built substantially rotationally symmetrical. The heating device can be circular or cylindrical in cross section. However, this does not preclude that the heating device can be at least partially oval or elliptical in cross section. This means in particular that the heating device can have an oval cross section.

With respect to the direction of gravity, the center axis of the heating device is placed below the center axis of the storage container. Accordingly, the center axis of the storage container is arranged above the center axis of the heating device with respect to the direction of gravity. The center axis of the heating device and the center axis of the storage container are arranged parallel to each other and at a distance from each other.

When filling the cryogen into the inner container, the inner container, which may be firmly connected to the outer container, shrinks along the longitudinal direction due to heat. The longitudinal direction is oriented parallel to the center axis of the storage container. Since the inner container shrinks, it moves relative to the outer container by the change in length. The change in length can, for example, be several millimeters. This change in length can be compensated for by the length compensator.

In the present case, “compensating” is understood to mean that the length compensator is pushed together or pulled apart so that no heat-induced stresses are introduced into the heating device, the inner container or the outer container. The length compensator is therefore telescopic. In the present case, “telescoping” is understood in particular to mean that the length compensator can be pushed together or folded together or pulled apart or unfolded, at least partially. The length compensator is therefore elastically, in particular spring-elastically, deformable.

According to one embodiment, the storage container further comprises a vacuum space that is provided between the inner container and the outer container, wherein the heating device has an outer shell which is guided through the vacuum space into the inner container, and wherein an interior space of the heating device enclosed by the outer shell is fluidically separated from the vacuum space.

As previously mentioned, the inner container is completely enclosed or encapsulated by the outer container. A gap in the form of the vacuum space is provided between the inner container and the outer container. The vacuum space is evacuated. In the present case, a “vacuum” is understood to mean in particular a pressure of less than 300 mbar, preferably less than 10⁻³ mbar, more preferably less than 10⁻⁷ mbar. The storage container is therefore vacuum insulated or vacuum dampened. The outer shell is preferably guided below the phase boundary into the inner container so that the outer shell is flushed by the cryogen. The outer shell is preferably tubular. The previously mentioned heating unit of the heating device is arranged inside the outer shell and is designed to introduce heat into the cryogen. The fact that the interior space enclosed by the outer shell is “fluidically” separated from the vacuum space is to be understood in particular to mean that there is no fluid connection between the interior space of the heating device and the vacuum space. This means in particular that the interior space of the heating device enclosed by the outer shell is not in fluid connection with the vacuum space.

According to a further embodiment, the interior space is filled with a heat-conducting medium.

The heat-conducting medium can be a gas. The terms, “medium” and “gas” are therefore interchangeable as desired. The heat-conducting medium can also be or have a liquid. The heat-conducting medium can have a liquid phase, a solid phase and a gas phase. The heat-conducting medium can be part of the heating device. The heat-conducting medium is used to ensure heat conduction between the heating element and the outer shell of the heating device and therefore between the heating element and the liquid phase of the cryogen. An inert gas, for example, can be used as a suitable gas. The heat-conducting medium or gas can be helium. In particular, the heat-conducting medium should be selected such that no phase change of the heat-conducting medium occurs over the entire operating temperature range of the storage container. In particular, the heat-conducting medium should not freeze or freeze out. Alternatively, a phase change of the heat-conducting medium can be provided during operation of the heating device. This can be achieved by a suitable selection of the heat-conducting medium. A filling pressure and the heat-conducting medium are preferably selected such that, at a minimum temperature and a maximum temperature which can occur during operation of the storage container, there is a difference to an ambient pressure of the surroundings and to an operating pressure of the storage container. This aforementioned difference makes it possible to reliably detect a possible leak between the liquid zone and the interior space of the outer shell, between the vacuum space and the interior space of the outer shell and/or between the surroundings and the interior of the outer shell. In case the cryogen is hydrogen, the heat-conducting medium is preferably helium. By using helium as a heat-conducting medium, the heat-conducting medium can be reliably prevented from freezing out when the storage container is operated with hydrogen. For example, any overpressure that allows leakage monitoring can be selected as the filling pressure for the interior space of the outer shell. Preferably, a pressure between 1.1 and 200 bar, in particular between 5 and 10 bar, is selected as the filling pressure. Monitoring the interior space therefore allows safety-related leak monitoring in order to meet the requirements for the separation of electrical systems and process systems and for separation from the surroundings in accordance with relevant regulations.

According to a further embodiment, the outer shell is firmly connected to the inner container.

In particular, the outer shell is integrally bonded to the inner container. Given integrally bonded connections, the connection partners are held together by atomic or molecular forces. Integrally bonded connections are non-releasable connections that can only be separated by destroying the connecting means and/or the connection partners. An integrally bonded connection can be effected, for example, by adhesive bonding, soldering, welding, or vulcanization. For example, the outer shell is soldered or welded into the inner container. As previously mentioned, the inner container has a base section which is connected at the front by two cover sections. The outer shell is in particular firmly connected to one of the cover sections. The outer shell can be soldered or welded into one of the cover sections of the inner container.

According to a further embodiment, the outer shell is passed through the length compensator.

The length compensator is in particular cylindrical or tubular. The length compensator can be constructed rotationally symmetrically to the center axis of the heating device. The length compensator runs around or encloses the outer shell.

According to a further embodiment, the length compensator is firmly connected to the outer container, wherein the outer shell is firmly connected to the length compensator.

In particular, the length compensator is integrally bonded to the outer container. As previously mentioned, the outer container has a base section which is closed at the end face by a cover section. The length compensator is firmly connected to one of the cover sections. In particular, the length compensator can be soldered or welded to the outer container. The outer shell is also integrally bonded to the length compensator. For example, the outer shell can be welded or soldered to the length compensator. The outer shell is therefore directly connected to the inner container and indirectly connected to the outer container via the length compensator. This means that the length compensator is arranged between the outer shell and the outer container.

According to a further embodiment, the length compensator has a bellows section that can be unfolded and folded together along a longitudinal direction of the storage container for length compensation along the longitudinal direction.

In addition to the bellows section, the length compensator has a first connecting section which is connected to the outer container and a second connecting section which is connected to the outer shell of the heating device. The bellows section is arranged between the two connecting sections. The bellows section is in particular a folding bellows and can therefore also be referred to as such. The bellows section is telescopic. The bellows section can, for example, be made of a metallic material.

According to a further embodiment, the length compensator encloses an interior space which is fluidically connected to the vacuum space.

This means in particular that the interior space of the length compensator is also exposed to the vacuum prevailing in the vacuum space. The fact that the interior space of the length compensator is “fluidically” connected to the vacuum space is to be understood in the present case in particular to mean that the interior space of the length compensator is in fluid connection with the vacuum space.

According to a further embodiment, the heating device comprises a heating unit for introducing heat into the cryogen and a connecting piece, wherein the heating unit and the connecting piece are arranged within the outer shell.

In particular, the heating unit has a support element as mentioned above, on which a heating element in the form of a heating wire as mentioned above is wound. The heating unit is attached to the connecting piece, in particular at the front. The heating unit can be firmly connected to the connecting piece. In particular, the heating unit is placed entirely within the inner container, in particular within the liquid zone.

According to a further embodiment, the outer shell has a flange, wherein the connecting piece has a flange, and wherein the flange of the outer shell and the flange of the connecting piece are positively connected to one another.

A form-fitting connection is produced by at least two connection partners engaging with each other or behind each other. In the present case, the flange of the outer shell and the flange of the connecting piece can be screwed together. The flange of the outer shell and the flange of the connecting piece seal against each other fluid-tight. For this purpose, so-called welding lip seals can be provided, for example.

According to a further embodiment, the heating unit is arranged completely within the inner container, wherein the connecting piece is guided from the surroundings of the storage container through the vacuum space into the inner container.

The connecting piece comprises the aforementioned flange which is provided on a rod-shaped or bar-shaped base section. An end section is provided on the end side of the base section facing away from the flange, which carries the heating unit. With the aid of the connecting piece, the heating unit can be pushed into the inner container.

According to a further embodiment, the outer shell has a connection projecting into the surroundings and is fluidically connected to the interior space, wherein the connection is closed fluid-tightly.

For example, the heat-conducting medium can be filled into the interior space of the outer shell via the connection. The connection can have a suitable valve for this purpose. The connection can also be used to monitor the pressure in the interior space. For this purpose, a sensor, in particular a pressure sensor, can be provided on the connection. The connection can have a plurality of different sensors such as pressure sensors, temperature sensors, optical sensors, sensors which are capable of detecting the cryogen and/or the heat-conducting medium, or the like.

According to a further embodiment, the connecting piece is made of stainless steel, a composite material and/or plastics material.

In particular, the connecting piece is made of a poorly heat-conducting material. In addition, the connecting piece has an elongated rod-shaped geometry. This reduces heat conduction with the aid of the connecting piece. For example, the connecting piece is made of polytetrafluoroethylene (PTFE). A fiber-reinforced plastics material, in particular an epoxy resin, can be used as a composite material. Glass fibers or carbon fibers, for example, can be used as reinforcing fibers.

According to a further embodiment, the heating unit has connection lines and/or a sensor line which are passed through the connecting piece.

For example, the heating unit has two connection lines for the heating element. The connection lines are guided from the heating unit through the connecting piece and the flange of the connecting piece to the surroundings. The heating unit can have one or more temperature sensors. Each temperature sensor is assigned a sensor line as mentioned above. The sensor line is also guided from the heating unit through the connecting piece to the flange of the connecting piece and from there into the surroundings.

According to a further embodiment, the connecting piece is rod-shaped.

In the present case, “rod-shaped” means an elongated geometry. For example, the connecting piece has a circular cross section. The connecting piece can be hollow. In this case, the connecting piece is a rod with an annular cross section.

In the present case, “a(n)” is not necessarily to be understood as limiting to exactly one element. It is rather the case that a plurality of elements, such as two, three, or more, may also be provided. Any other numerical word used herein is also not to be understood as meaning an exact limitation to exactly the corresponding number of elements. Rather, numerical differences upwards or downwards are possible.

Further possible implementations of the storage container also comprise not explicitly mentioned combinations of features or embodiments described above or below with respect to the exemplary embodiments. A person skilled in the art will also add individual aspects as improvements or additions to the respective basic form of the storage container.

Further advantageous embodiments of the storage container are the subject matter of the dependent claims and of the exemplary embodiments of the storage tank described below. The storage container is explained below in more detail on the basis of preferred embodiments while making reference to the provided figures.

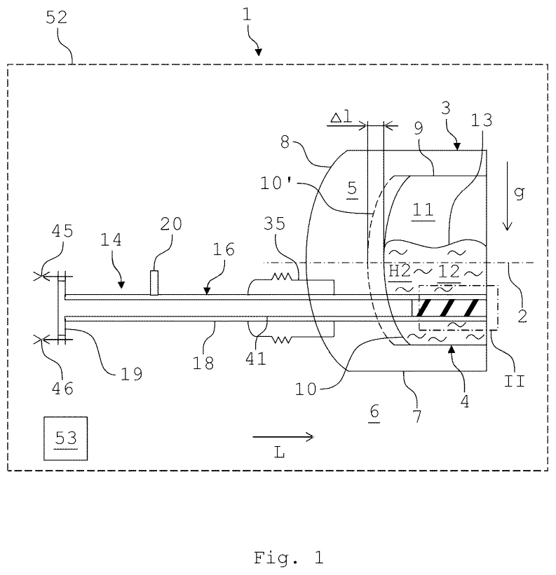

FIG. 1 shows a schematic sectional view of an embodiment of a storage container;

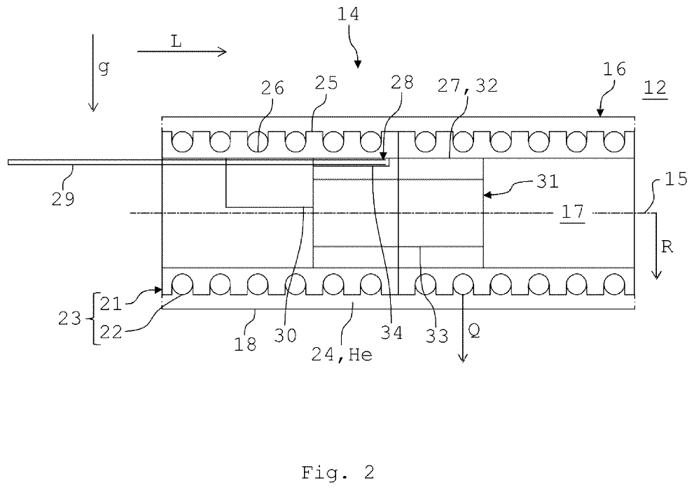

FIG. 2 shows the detailed view Il in accordance with FIG. 1;

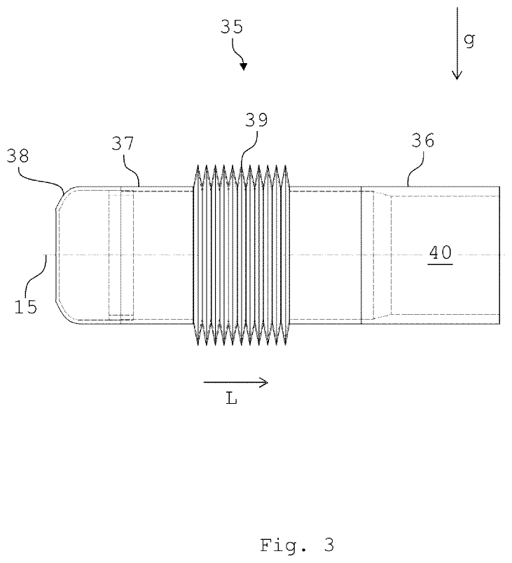

FIG. 3 shows a schematic view of an embodiment of a length compensator for the storage container according to FIG. 1;

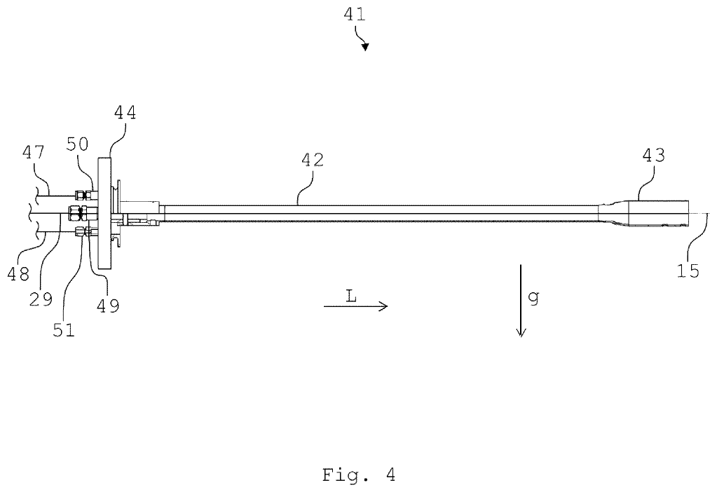

FIG. 4 shows a schematic view of an embodiment of a connecting piece for the storage container according to FIG. 1;

In the figures, the same or functionally equivalent elements have been provided with the same reference signs unless otherwise indicated.

FIG. 1 shows a schematic sectional view of an embodiment of a storage container 1. FIG. 2 shows the detailed view II in accordance with FIG. 1. In the following, reference is made simultaneously to FIGS. 1 and 2.

The storage container 1 can also be referred to as a storage tank. The storage container 1 is suitable for accommodating liquid hydrogen H2 (boiling point 1 bara: 20.268 K=−252.882° C.). The storage container 1 can therefore also be referred to as a hydrogen storage container or as a hydrogen storage tank. However, the storage container 1 can also be used for other cryogenic liquids. Examples of cryogenic fluids or liquids, or cryogens for short, are liquid helium He in addition to the aforementioned liquid hydrogen H2 (boiling point 1 bara: 4.222 K=−268.928° C.), liquid nitrogen N2 (boiling point 1 bara: 77.35 K=−195.80° C.) or liquid oxygen O2 (boiling point 1 bara: 90.18 K=−182.97° C.).

The storage container 1 is suitable for use in or on a vehicle (not shown). The vehicle can be, for example, a watercraft, in particular a ship. The vehicle can be referred to as a maritime vehicle. In particular, the vehicle can be a maritime passenger ferry. Alternatively, the vehicle can also be a land vehicle. However, it is assumed below that the vehicle is a watercraft.

The storage container 1 is rotationally symmetrical with respect to a symmetry or center axis 2. The center axis 2 can be oriented perpendicular to a direction of gravity g. This means that the storage container 1 is in a lying or horizontal position. Alternatively, the center axis 2 can be oriented parallel to the direction of gravity g. That is, the storage container 1 can also be positioned upright or vertically. A longitudinal direction L of the storage container 1 is oriented along the center axis 2. In the orientation of FIG. 1, the longitudinal direction L runs from left to right.

The storage container 1 comprises an outer container 3 which is rotationally symmetrical with respect to the center axis and an inner container 4 which is rotationally symmetrical with respect to the center axis 2. The inner container 4 is arranged completely inside the outer container 3. The outer container 3 and/or the inner container 4 can for example be made of stainless steel.

A vacuum space 5 is provided between the outer container 3 and the inner container 4, which is gap-shaped at least in sections. In the vacuum space 5, a negative pressure prevails compared to the surroundings 6 of the storage container 1. The surroundings 6 can also be referred to as the atmosphere. This means that the terms “surroundings” and “atmosphere” can be used interchangeably.

An insulating element can be provided in the vacuum space 5, which at least partially or completely fills the vacuum space 5. The insulation element can have a multilayer insulation layer (MLI) or be designed as such. Such a multilayer insulation layer comprises a plurality of alternately arranged layers of perforated and embossed aluminum foil as a reflector and glass paper as spacers between the aluminum foils. The glass paper can be perforated and/or punched.

The outer container 3 comprises a tubular or cylindrical base section 7 which can have a rotationally symmetrical design in relation to the center axis 2. The base section 7 is closed at both ends by means of a cover section 8, of which only one cover section 8 is shown in FIG. 1. In cross section, the base section 7 can have a circular or approximately circular geometry. The cover sections 8 are domed. The cover sections 8 are domed in opposite directions so that the two cover sections 8 are domed outward in relation to the base section 7. The outer container 3 is fluid-tight, in particular gas-tight.

The inner container 4, like the outer container 3, comprises a tubular or cylindrical base section 9 which is rotationally symmetrical in relation to the center axis 2. The base section 9 is closed on both sides by a cover section 10, of which only one cover section 10 is shown in FIG. 1. In cross section, the base section 9 can have a circular or approximately circular geometry. The cover sections 10 are domed. In particular, the cover sections 10 are domed in opposite directions so that the two cover sections 10 are domed outward in relation to the base section 9. The inner container 4 is fluid-tight, in particular gas-tight.

The liquid hydrogen H2 is accommodated in the inner container 4. As long as the hydrogen H2 is in the two-phase region, a gas zone 11 having vaporized hydrogen H2 and a liquid zone 12 having liquid hydrogen H 2 can be provided in the inner container 4. After being filled into the inner container 4, the hydrogen H2 therefore has two phases having different aggregate states, namely liquid and gaseous. That is to say, in the inner container 4, a phase boundary 13 is provided between the liquid hydrogen H2 and the gaseous hydrogen H2.

The storage container 1 comprises a heating device 14. The heating device 14 is shown sectionally in FIG. 2. The heating device 14 is designed to introduce heat Q into the liquid hydrogen H2. The heating device 14 is operated electrically. Therefore, the heating device 14 can also be referred to as an electrical heating device or as a heater, in particular as an electric heater.

The heating device 14 projects through the cover sections 8, 10 from the surroundings 6 into the inner container 4, in particular into the liquid zone 12. The part of the heating device 14 projecting into the inner container 4 is preferably flushed by the liquid hydrogen H2 of the liquid zone 12.

The following technical challenges must be overcome for the installation of the heating device 14. Electrical conductors cannot be installed in the vacuum space 5 because the poor heat conduction within the vacuum space 5 poses a risk of the electrical conductors overheating. Electronics of the heating device 14 cannot be installed in the vacuum space 5 since there is also a risk in this case of overheating.

By reducing the insulating effect with respect to the inner container 4 by introducing the heating device 14, the insulation of the inner container 4 can be damaged, and therefore increased heat input from the surroundings 6 to the inner container 4 can occur. Convection can occur due to the formation of a gas roller between the cold inner container 4 and the warm surroundings 6.

It is desirable to compensate for changes in length between the inner container 4 and the outer container 3 when the inner container 4 is heated or cooled, or when the temperature in the surroundings 6 changes if the inner container 4 and the outer container 3 are firmly connected to one another. The heating device 14 should be replaceable without breaking the vacuum. These challenges are solved with the heating device 14.

The heating device 14 is rotationally symmetrical with respect to an axis of symmetry or center axis 15. The center axis 15 can be oriented parallel to the center axis 2. The center axis 15 is placed below the center axis 2 with respect to the direction of gravity g. The heating device 14 is further assigned a radial direction R. The radial direction R is oriented to be perpendicular to the center axis 15 and away therefrom.

The heating device 14 comprises a fluid-tight outer shell 16. The outer shell 16 is tubular and can therefore also be referred to as an outer tube. The outer shell 16 is preferably made of a metal material, preferably of stainless steel. The outer shell 16 is preferably made of a material that conducts heat well.

The outer shell 16 is guided through the two cover sections 8, 10 into the liquid zone 12. This means that the outer shell 16 extends partially into the surroundings 6 and partially into the inner container 4, in particular into the liquid zone 12. The outer shell 16 can be soldered or welded into the cover section 10 of the inner container 4. The outer shell 16 is not connected to the cover section 8 of the outer container 3. The outer shell 16 can also be made of a copper alloy, an aluminum alloy, glass, glass ceramic or ceramic.

The outer shell 16 is rotationally symmetrical in relation to center axis 15. The outer shell 16 can be circular in cross section. Alternatively, the outer shell 16 can also be slightly oval or elliptical in cross section. The outer shell 16 is therefore circumferentially closed. The outer shell 16 encloses an interior space 17. The interior space 17 can be referred to as the interior space of the outer shell 16 or as the interior space of the heating device 14. The interior space 17 can also be referred to as the heating interior space. The interior space 17 is filled with a heat-conducting medium. The heat-conducting medium is preferably a gas, in particular helium He. The outer shell 16 is fluid-tight.

The outer shell 16 comprises a tubular base section 18 which is rotationally symmetrical with respect to the center axis 15. In addition to the base section 18, the outer shell 16 comprises a flange 19 which projects into the surroundings 6. Facing away from the flange 19, the outer shell 16 has a cover section (not shown) which closes the outer shell 16 fluid-tight. This cover section is placed inside the inner container 4.

Outside the outer container 3, the outer shell 16 has a connection 20 which can be closed fluid-tightly. With the aid of the connection 20, for example, the interior space 17 can be filled with helium He. Furthermore, the connection 20 can also be used to monitor the heating device 14. For example, a pressure drop or pressure increase in the interior space 17 can be detected via the connection 20. The connection 20 is placed outside the storage container 1 in the surroundings 6.

In addition to the outer shell 16, the heating device 14 has a tubular support element 21 which carries a wire-shaped heating element 22. The support element 21 can also be called a support tube. The support element 21 is preferably rotationally symmetrical in relation to center axis 15. The support element 21 is made of a material that conducts heat well. For example, the support element 21 is made of a metal material, in particular a copper alloy or an aluminum alloy. However, the support element 21 can also be made of glass, glass ceramics or ceramics. The heating element 22 and the support element 21 together form a heating unit 23 of the heating device 14.

The support element 21 can be an integral component, in particular a materially integral component. “Integral” or “one-piece” is understood to mean that the support element 21 is a single component which is not composed of a plurality of subassemblies or components. In the present case, “materially integral” is understood to mean in particular that the support element 21 is made entirely of the same material. Alternatively, the support element 21 can also be multi-part or multi-piece. In the present case, the support element 21 is constructed from a plurality of subassemblies or components.

The support element 21 extends in the longitudinal direction L into the inner container 4. The support element 21 is preferably arranged completely within the inner container 4. The support element 21 is accommodated in the outer shell 16. This means in particular that the support element 21 is placed in the interior space 17. Preferably, the support element 21 is placed centrally with respect to the center axis 15 so that a gap 24 filled with helium He is provided between the support element 21 and the base section 18 and extends completely around the support element 21.

The gap 24 can have a gap width of 0.5 to 1 millimeters. The gap width is selected to be as small as possible and as large as necessary to allow the support element 21 with the heating element 22 to be inserted into the outer shell 16. The gap 24 is part of the interior space 17. The gap 24 is optional. Alternatively, the support element 21 can rest on the inside of the outer shell 16. The heat transfer can thereby be improved.

A cylindrical outer side 25 of the support element 21 faces the outer shell 16. The gap 24 is provided between the outer side 25 and the outer shell 16. On the outer side 25, a groove 26 is provided which runs in a helical or spiral manner around the support element 21 and accommodates the heating element 22. The heating element 22 is preferably a heating wire which is wound onto the support element 21.

In the event that the support element 21 is made of an electrically conductive material, the heating element 22 can have an electrical insulation which electrically insulates the heating element 22 from the support element 21. For example, the aforementioned heating wire can be embedded in magnesium oxide powder which is encapsulated by a non-current-conducting metallic casing, for example a stainless steel casing. In this case, the term “heating element” can therefore be understood to mean a metallic-mineral-insulated heating wire. The groove 26 is optional. The heating element 22 can also be wound onto the support element 21 without the groove 26.

A cylindrical inner side 27 of the support element 21 faces away from the outer side 25. The inner side 27 can be realized by a hole passing through the center of the support element 21. The heating device 14 has at least one temperature sensor 28 with a sensor line 29. The temperature of the heating device 14 can be detected with the aid of the temperature sensor 28. The temperature sensor 28 comprises a fastening tab 30. As an alternative to the fastening tab 30, it is also possible to provide other fastening types, for example clamping, screwing, soldering or plugging.

The temperature sensor 28 is held or fastened with the aid of a fastening element 31. The fastening element 31 is made of a material with good heat conduction, for example a copper alloy or an aluminum alloy. The fastening element 31 is tubular. The fastening element 31 is arranged within the support element 21. For example, the fastening element 31 is pressed into the support element 21. The fastening element 31 can be an integral component, in particular a materially integral component. Alternatively, the fastening element 31 can also be multi-part or multi-piece.

The fastening element 31 is rotationally symmetrical in relation to center axis 15. The fastening element 31 comprises a cylindrical outer side 32 which rests against the inner side 27 of the support element 21. The fastening element 31 further comprises a cylindrical inner side 33, which is realized, for example, by a hole provided centrally in the fastening element 31. The helium He can therefore flow through the fastening element 31.

For each temperature sensor 28, the fastening element 31 has a receiving hole 34 into which the respective temperature sensor 28 is inserted. The receiving hole 34 is provided in the front side of the fastening element 31 and extends along the longitudinal direction L into the fastening element 31. The receiving hole 34 runs parallel to the center axis 15. The receiving hole 34 can be a blind hole. Viewed along the radial direction R, the receiving hole 34 lies directly below the outer side 32.

The heating device 14 further comprises a length compensator 35. FIG. 3 shows a schematic view of an embodiment of such a length compensator 35.

The length compensator 35 enables length compensation along the longitudinal direction L. The length compensator 35 is constructed rotationally symmetrically to the center axis 15. The outer shell 16 is passed through the length compensator 35.

The length compensator 35 has a cylindrical first connecting section 36 which is firmly connected to the cover section 8 of the outer container 3. For example, the first connecting section 36 is soldered or welded into the cover section 8. In addition to the first connecting section 36, a second connecting section 37 is provided. The second connecting section 37 comprises a rounding 38 running around the center axis 15. By means of the rounding 38, the second connecting section 37 is firmly connected to the base section 18 of the outer shell 16, for example soldered or welded thereto.

A bellows section 39 is arranged between the first connecting section 36 and the second connecting section 37. The bellows section 39 can be pushed together and pulled apart along the longitudinal direction L in order to enable length compensation along the longitudinal direction L. The length compensator 35 is preferably an integral component, in particular a materially integral component. The length compensator 35 can be made of metal. The length compensator 35 encloses an interior space 40 which is fluidically connected to the vacuum space 5.

Now returning to FIG. 1, the inner container 4, which is firmly connected to the outer container 3 at an end section facing away from the cover section 10, shrinks along the longitudinal direction L due to heat when filling in the liquid hydrogen H2. In FIG. 1, a starting position of the cover section 10, in which the inner container 4 is not yet filled with the liquid hydrogen H2, is designated by a dashed line and by the reference sign 10′.

If the inner container 4 is now filled with the liquid hydrogen H2, the cover section 10 moves to the right in the orientation of FIG. 1 by a change in length ΔI. The change in length ΔI can, for example, be several millimeters. This change in length ΔI can be compensated by the length compensator 35, in particular by the bellows section 39. In the present case, “compensating” means that the bellows section 39 is pushed together or pulled apart so that no heat-induced stresses are introduced into the outer shell 16, the inner container 4 or the outer container 3.

The heating device 14 further comprises a connecting piece 41. FIG. 4 shows a schematic view of an embodiment of such a connecting piece 41.

The connecting piece 41 is accommodated in the outer shell 16. The connecting piece 41 comprises a base section 42 extending along the longitudinal direction L. The base section 42 is followed by an end section 43. By means of the end section 43, the connecting piece 41 can be connected to the heating unit 23. The connecting piece 41 therefore carries the heating unit 23.

Facing away from the end section 43, the connecting piece 41 has a flange 44. The flange 44 is connected to the flange 19 of the outer shell 16 by means of connecting elements 45, 46 (FIG. 1). The connecting elements 45, 46 can be screws. By means of the connecting elements 45, 46, the flanges 19, 44 can be easily connected to each other and separated from each other again. In order to seal the flanges 19, 44 against each other, welding lip seals can be provided.

The sensor line 29 as well as the connection lines 47, 48 of the heating element 22 are passed through the connecting piece 41. For this purpose, suitable bushings 49, 50, 51 are provided in the flange 44. The connecting piece 41 is preferably made of stainless steel. However, the connecting piece 41 can also be made of a plastics material.

Now returning to FIG. 1, the storage container 1 can be part of a cryogen supply system 52 which is suitable for providing a consumer 53, which in the present case is preferably a fuel cell, with gaseous hydrogen H2 at a defined supply pressure and a defined supply temperature. For example, the hydrogen H2 is supplied to the consumer 53 in gaseous form at a supply pressure of, for example, 1 to 2.5 bara and a temperature of, for example, 0 to +70° C., in particular from +10 to +25° C. However, the supply pressure can also be up to 6 bara.

The cryogen supply system 52 can be described as a hydrogen supply system. In addition to the storage container 1, the cryogen supply system 52 can comprise a vaporizer (not shown) which is suitable for vaporizing the liquid hydrogen H2 and supplying it to the consumer 53.

The design of the heating device 14 enables the insulating effect to be maintained with respect to the inner container 4 by using materials with a low thermal conductivity between the surroundings 6 and the inner container 4. For example, for this purpose, the connecting piece 41 can be made of stainless steel or a plastics material. It enables a separation of the connection lines 47, 48 and the associated electronics from the vacuum space 5 by an additional barrier in the form of the outer shell 16 between the connecting lines 47, 48 and the vacuum space 5.

The heat generated by the resistance in the electrical connection lines 47, 48 is dissipated by a suitable choice of material for the connecting piece 41 between the heating unit 23 and the flange 44. On the one hand, it must be ensured that the material dissipates the heat generated in the connection lines 47, 48 and, on the other hand, that the cold losses to the surroundings 6 are as low as possible.

Due to possible cold losses, it is advantageous if the connecting piece 41 is designed elongated so that the insulating effect is maintained as far as possible. Stainless steel is a suitable material for the connecting piece 41 since this leads to comparatively low heat conduction to the outside, which is nevertheless sufficient to dissipate heat from the electrical connection lines 47, 48. However, other poorly thermally conductive materials, such as plastics materials or ceramics, can also be used for the connecting piece 41.

It is possible to suppress the convection roller between the cold inner container 4 and the warm surroundings 6 and the associated cold losses in the inner container 4 by filling the gap 24 with an insulating material, for example in the form of mineral wool.

The length compensator 35 enables compensation of the resulting change in length ΔI between the inner container 4 and the outer container 3, which can arise due to different heating or cooling of the inner container 4 and the outer container 3. The change in length Al can also be compensated by an additional axial stop, which can be integrated into the heating device 14.

The heating device 14 is designed to allow easy replacement of the heating unit 23. For this purpose, the flange connection between flanges 19, 44 is provided. In order to achieve 100% gas tightness, welding lip seals are used on flanges 19 and 44. However, other seals are also possible.

Different heat-conducting media such as helium He can be used to fill the gap 24 of the heating device 14. A size of the space between the heating device 14 and the vacuum space 5 is variable and can be adapted to the geometry of the heating device 14.

Different insulations can be used between the heating device 14 and the surroundings 6. The outer shell 16 forms an independent space between the inner container 4 and the outer container 3. There is no fluidic connection to the inner container 4. Different flange seals can be used on flanges 19, 44.

Although the present invention has been described with reference to embodiments, it can be modified in many ways within the scope of the claims.

### REFERENCE SIGNS USED

1 Storage container
2 Center axis
3 Outer container
4 Inner container
5 Vacuum space
6 Surroundings
7 Base section
8 Cover section
9 Base section
10 Cover section
10′Cover section
11 Gas zone
12 Liquid zone
13 Phase boundary
14 Heating device
15 Center axis
16 Outer shell
17 Interior space
18 Base section
19 Flange
20 Connection
21 Support element
22 Heating element
23 Heating unit
24 Gap
25 Outer side
26 Groove
27 Inner side
28 Temperature sensor
29 Sensor line
30 Fastening tab
31 Fastening element
32 Outer side
33 Inner side
34 Receiving hole
35 Length compensator
36 Connecting section
37 Connecting section
38 Rounding
39 Bellows section
40 Interior space
41 Connecting piece
42 Base section
43 End section
44 Flange
45 Connecting element
46 Connecting element
47 Connection line
48 Connection line
49 Bushing
50 Bushing
51 Bushing
52 Cryogen supply system
53 Consumer
g Direction of gravity
He Helium/medium
H2 Hydrogen/cryogen
L Longitudinal direction
Q Heat
R Radial direction
ΔI Change in length

1. A storage container for storing a cryogen, having an inner container for holding the cryogen, an outer container enclosing the inner container, and a heating device for pressure build-up within the inner container by introducing heat into the cryogen, wherein the heating device has a length compensator which is designed to compensate for a heat-induced change in length (ΔI) of the inner container.

2. The storage container according to claim 1, further comprising a vacuum space that is provided between the inner container and the outer container, wherein the heating device has an outer shell which is guided through the vacuum space into the inner container and wherein an interior space of the heating device enclosed by the outer shell is fluidically separated from the vacuum space.

3. The storage container according to claim 2, wherein the interior space is filled with a heat-conducting medium .

4. The storage container according to claim 2, wherein the outer shell is firmly connected to the inner container.

5. The storage container according to claim 2, any wherein the outer shell passes through the length compensator.

6. The storage container according to claim 2, wherein the length compensator is firmly connected to the outer container, and wherein the outer shell is firmly connected to the length compensator.

7. The storage container according to claim 2, wherein the length compensator has a bellows section that can be unfolded and folded together along a longitudinal direction of the storage container for length compensation along the longitudinal direction.

8. The storage container according to claim 2, wherein the length compensator encloses an interior space which is fluidically connected to the vacuum space.

9. The storage container according to claim 2, wherein the heating device has a heating unit for introducing heat into the cryogen and a connecting piece, wherein the heating unit and the connecting piece are arranged within the outer shell.

10. The storage container according to claim 9, wherein the outer shell has a flange wherein the connecting piece has a flange and wherein the flange of the outer shell and the flange of the connecting piece are positively connected to one another.

11. The storage container according to claim 9, wherein the heating unit is arranged completely within the inner container, and wherein the connecting piece is guided from the surroundings of the storage container through the vacuum space into the inner container.

12. The storage container according to claim 9, wherein the outer shell has a connection projecting into the surroundings and is in fluidic connection with the interior space and wherein the connection is closed fluid-tightly.

13. The storage container according to claim 9, wherein the connecting piece is made of stainless steel, a composite material and/or plastics material.

14. The storage container according to claim 9, wherein the heating unit has connection lines and/or a sensor line which are passed through the connecting piece.

15. The storage container according to claim 9, wherein the connecting piece is rod-shaped.
